(19) United States
(12) Patent Application Publication
(10) Pub. No.: US 2021/0390541 A1
(43) Pub. Date: Dec. 16, 2021

(54) SYSTEMS AND METHODS FOR MANAGING AND SHARING TRANSACTION INFORMATION IN A DISTRIBUTED COMMUNICATION SYSTEM

(71) Applicant: OCEAN SPACE, INC., Redmond, WA (US)

(72) Inventors: Sajeed Ahmed, Bellevue, WA (US); Mohammed Moinuddin, Redmond, WA (US)

(21) Appl. No.: 17/286,471

(22) PCT Filed: Oct. 10, 2019
(86) PCT No.: PCT/US19/55672

§ 371 Date: Apr. 18, 2021

Related U.S. Application Data
(60) Provisional application No. 62/747,541, filed on Oct. 18, 2018.

(51) Int. Cl. G06Q 20/40; G06Q 20/38; G06Q 20/06

(52) U.S. Cl. CPC G06Q 20/401; G06Q 20/405; G06Q 20/06; G06Q 20/389; G06Q 20/382

(57) ABSTRACT

A social transaction management system may include an event transaction object, a personal transaction unit and a mobile application engine. The event transaction object is configured to track transactions of multiple users across multiple events, wherein the tracked transactions have defined transaction parameters. The personal transaction unit is communicatively coupled to at least one event transaction object and configured to determine an accounting of total transactions for each user per event based on associated event transaction object(s). The mobile application engine is communicatively coupled to the event transaction object(s) to create a communication portal between multiple users across multiple events. The system may create a transaction entry, transmit the transaction entry to a user device, receive an acknowledgement responsive to the notification from the user device and update the status of the transaction entry on both the receiving and sending user devices.

### BACKGROUND

Today's electronic devices, such as desktop computer or portable electronic devices, allow users to manage transactions with a bank or a merchant. For example, a user may pay for multiple purchases using a credit card, and later obtain a credit card statement that lists all of the transactions of the user, and the user owes a total amount to the credit card company. This list of transactions reflects the user's liability to a single entity, e.g., the bank. However, existing technologies do not allow a user's electronic device to easily keep track of the liabilities of the user to other users. For example, a user may diligently keep track of all his/her liabilities to the other users. However, other users may not keep track of the same liabilities. In other scenarios, in one or more events, the liabilities among multiple users across multiple events become even more unmanageable using the existing general purpose computing devices.

As such, it is desirable to establish systems and methods to automatically track and settle transactions (e.g., financial, goods, or services) between users transacting for a particular event, as well as efficient communication between transacting users.

### SUMMARY

Embodiments described herein include a social transaction management system, comprising an event transaction object configured to track transactions of first and second users for respective events. The tracked transactions have defined transaction parameters associated with respective ones of the events. A personal transaction unit may be communicatively coupled to the event transaction object and configured to determine an accounting of total transactions for each of the first and second users across the events, where the accounting of total transactions incorporates the defined transaction parameters associated with the respective events. Furthermore, a mobile application engine may be communicatively coupled to the event transaction object to create a communication portal between the first and second users and with the event transaction object, wherein the defined transaction parameters are set responsive to a command from at least one of the first and second users via the communication portal.

### BRIEF DESCRIPTION OF THE DRAWINGS

The foregoing and other features of the present disclosure will become more fully apparent from the following description and appended claims, taken in conjunction with the accompanying drawings. In the following figures, like numerals represent like items throughout the figures. Understanding that these drawings depict only several examples in accordance with the disclosure and are, therefore, not to be considered limiting of its scope, the disclosure will be described with additional specificity and detail through use of the accompanying drawings, in which:

FIG. 1 illustrates a schematic block diagram of an example of a distributed communication system in accordance with some examples disclosed herein.

FIGS. 2A-2C illustrate examples of data structures used for improving the communications among multiple electronic devices in accordance with some examples disclosed herein.

FIG. 3 illustrates an example of a process for sharing transaction information in accordance with some examples disclosed herein.

FIG. 4 illustrates an example of a process that may be implemented in an electronic device in accordance with some examples disclosed herein.

FIG. 5 illustrates an example of pairing two electronic devices in accordance with some examples disclosed herein.

FIGS. 6-11 illustrate examples of display regions on a display of an electronic device in accordance with some examples disclosed herein.

FIG. 12 illustrates a diagram of an example process of sharing transaction information in a communication system in accordance with some examples disclosed herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various examples of embodiments of the invention will now be described. The following description provides specific details for a thorough understanding and enabling description of these examples. One skilled in the relevant art will understand, however, that embodiments of the invention may be practiced without many of these details. Likewise, one skilled in the relevant art will also understand that embodiments incorporate many other obvious features not described in detail herein. Additionally, some well-known structures or functions may not be shown or described in detail below, so as to avoid unnecessarily obscuring the relevant description.

The terminology used herein is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

The figures along with the following discussion provide a brief, general description of a suitable environment in which embodiments of the invention can be implemented. Although not required, aspects of various embodiments are described below in the general context of computer-executable instructions, such as routines executed by a general purpose data processing module, e.g., a networked server computer, cloud server, mobile device, tablet, or personal computer. Those skilled in the relevant art will appreciate that embodiments can be practiced with other communications, data processing, or computer system configurations, including: Internet appliances, hand-held devices (including smart phones, tablets, notebooks, wearable computers, all manner of corded, landline, fixed line, cordless, cellular or mobile phones, smart phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While embodiments of the invention, such as certain functions, may be described as being performed on a single device, embodiments of the invention can also be practiced in distributed environments where functions or modules are shared among disparate processing devices, which are linked through a communications network, such as, for example, a Local Area Network (LAN), Wide Area Network (WAN), the Internet, Bluetooth, and Zigbee. In a distributed computing environment, program modules may be located in both local and remote memory storage devices.

Embodiments of the invention may be stored or distributed on tangible computer-readable media, including magnetically or optically readable computer discs, cloud servers, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of embodiments of the invention may be distributed over the Internet and via cloud computing networks or on any analog or digital network (packet switched, circuit switched, or other scheme).

The computer readable medium stores computer data, which data may include computer program code that is executable by a computer, in machine readable form. By way of example, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Embodiments of the invention are described herein with reference to operational illustration of modules having functional blocks to illustrate methods employed by modules to control a plurality of user devices coupled to a network where the users conduct transactions between one another individually or as a group. Transactions may take the form of financial transactions, exchange of goods, or exchange of services to name a few. It will be understood that each of the modules, blocks, engines, and combinations thereof may be implemented by analog or digital hardware and computer program instructions. The computer program instructions may be provided to a processor of a general purpose computer, special purpose computer, application-specific integrated circuit (ASIC), or other programmable data processing apparatus such that the instructions, which execute via the processor of the computer or other programmable data processing apparatus, implements the functions/acts specified in the functional blocks of the flowcharts and/or the operational modules.

In some embodiments, the methods illustrated by the functional blocks may occur out of the order noted in the operational illustration of the modules. For example, two blocks shown in succession may be executed substantially concurrently. Alternatively and/or additionally, the blocks may be executed in reverse order.

A module is a software, hardware, or firmware (or combination thereof) system, process or functionality, or component thereof, that performs or facilitates the processes, features, and/or functions described herein. A module may include sub-modules or engines. Software components of a module may be stored on a computer readable medium. Modules may be integral to one or more servers, or be loaded and executed by one or more servers. One or more modules may be grouped into an application.

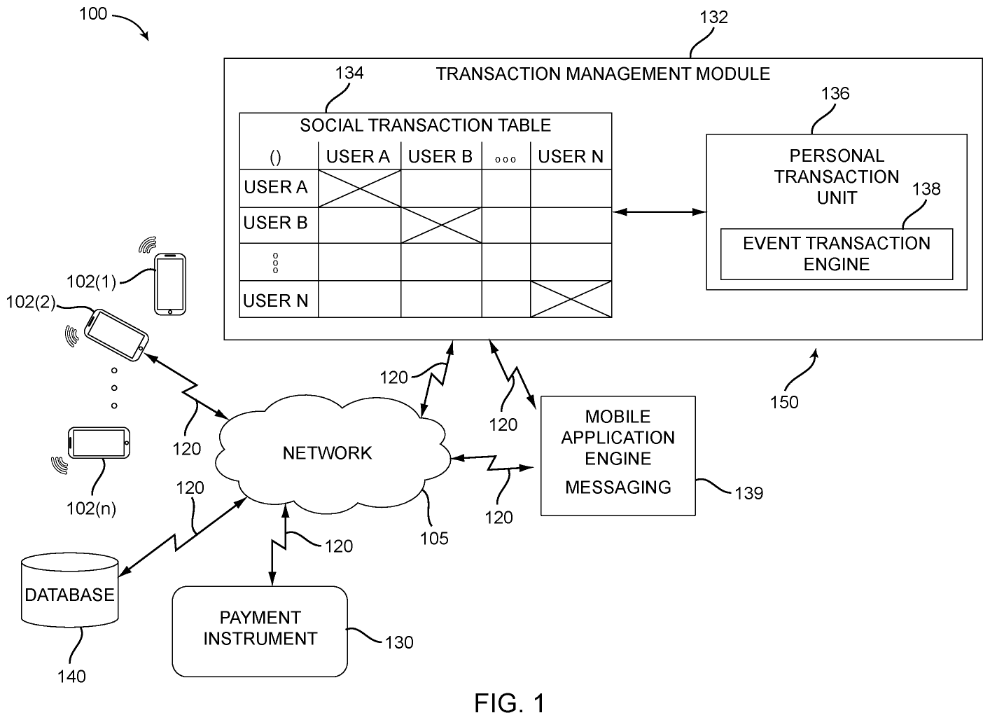

FIG. 1 illustrates a schematic block diagram of an example of a distributed communication system 100 in accordance with some examples disclosed herein. In some examples, the distributed communication system 100 may include a communication network 105, and one or more electronic devices 102(1), 102(2), . . . 102(n) (collectively referenced herein as 102) communicatively connected to the communication network 105 via a communication link 120. The communication link may include wired and wireless communication protocols, such as Ethernet, Local Area Network (LAN), Wide Area Network (WAN), the Internet, Bluetooth, and Zigbee, or other suitable communication protocols now or later developed. The distributed communication system 100 may also include one or more databases 140 which are also communicatively connected to the communication network 105 and accessible to the one or more electronic devices 102. Each of the electronic devices 102 may be a desktop computer, a portable electronic device, such as a mobile electronic device. In a non-limiting example, one of the electronic devices 102 may be a mobile electronic device 110 having a mobile application engine installed thereon. The mobile electronic device 110 may have a display and communication applications, such as Messaging, that allow the device to communicate with other electronic devices on the communication network. The distributed communication system 100 may also include a payment instrument 130 communicatively connected to the communication network 105 and configured to facility payment transactions for any of the electronic devices 102, each of which may be associated with a user. The payment instrument 130 may include an application such as Paypal, Venmo, Zelle, or a program running on a computer system of a bank or credit union, or on a cloud. In some scenarios, the system, e.g., 100, may operate to allow for each of the user's to separately transmit payment to the other via a financial instrument without having to rely on the system for implementing the financial transaction with other user devices.

With further reference to FIG. 1, system 100 may include a transaction management system 150. Transaction management system (TMS) 150 may be configured to maintain payment transactions (e.g., monetary, goods, service) among two users or groups of users in a distributed communication system and facilitate each electronic device in the communication system to take part in multiple events of various groups and track payments. A transaction may generally include an exchange of at least one of a currency, a good, or a service between users. In the distributed communication system 100, the electronic devices 102 may be communicatively coupled to the TMS 150. In one embodiment, a mobile device application may be installed on the electronic devices 102 to allow for communication between the users of the devices 102 and the TMS 150. In some examples, the TMS 150 may include a transaction management module 132, which may include a social transaction table 134, personal transaction unit (PTU) 136 and mobile application engine 139. The social transaction table 134, the PTU 136 and the mobile application engine 139 may be communicatively coupled to each other to facilitate management of one or more transactions via ones of the mobile electronic devices 102. In some examples, PTU 136 may be communicatively coupled to an event transaction engine 138 and configured to determine an accounting of total transactions for each user across multiple events.

Event transaction engine 138 may be configured to track transactions of each user for respective one or more events, where the tracked transactions have defined transaction parameters associated with respective ones of the one or more events. In some examples, an event may include a social event, such as a social gathering, a party, an excursion trip, an entertainment show or a sports event. An event may also include a business event, such as a conference, a tradeshow, or a promotion event. An event may also include a service event, such as a haircut, a lawn service, a tax service or any service that includes a provider and a beneficiary. Each of the examples of an event may include one or more payment transactions among various participants of the event. For example, one user may owe another user an amount over a coffee break. One or more users in a party event may owe one or more other users for miscellaneous expenses incurred. A patron may owe a hairdresser an amount for a haircut service.

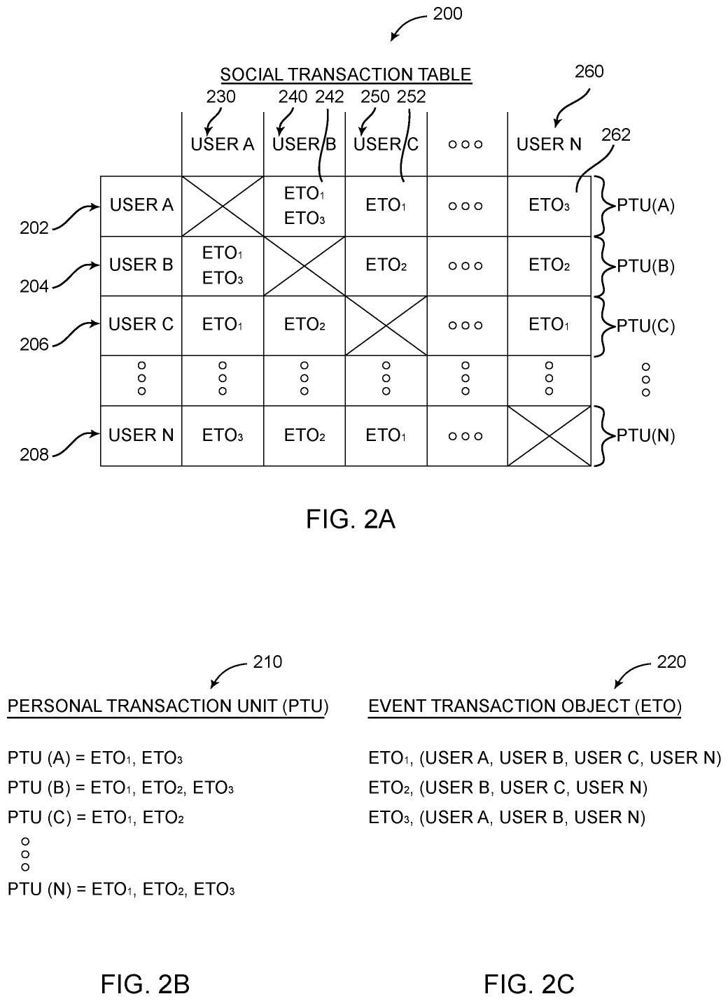

FIGS. 2A-2C illustrate examples of data structures used for improving the communications among multiple electronic devices in accordance with some examples disclosed herein. In FIG. 2C, in some examples, the event transaction engine (e.g., 138 in FIG. 1) may be implemented as one or more event transaction objects (ETO) 220. Each event transaction object 220 may include transactions associated with a given event, where the transactions may involve multiple users. For example, event transaction object ETO1 may track transactions associated with an event that involves user A, user B, user C and user N. ETO2 may track transactions associated with an event that involves user B, user C and user N. Similarly, ETO3 may track transactions associated with an event that involves user A, user B, and user N. In tracking the transactions associated with each event, an ETO may include defined transaction parameters associated with the event. The transaction parameters are further explained below in more detail.

In some examples, the transaction parameters may include an expense or income accumulated by each user at an event. In a non-limiting example, transaction parameters about the income of a party may include the contributions a user has made to the party, e.g., user A has contributed $10, or user A has purchased $10 of party supplies to be used for the party. In a non-limiting example, transaction parameters about the expense of a meeting event may include the money spent on the event, such as marketing cost, venue rental, supplies for decorating the venue advertising, etc. The transaction parameters associated with an event may also include the names of users involved in the event.

Additionally, and/or alternatively, the transaction parameters may also include an apportionment value assigned to a user. For example, the transaction parameters may include one or more weights allocated to each user per event. For example, user A may be responsible for 30% of the total expenses, user B responsible for 30% of the total expenses, but user C responsible for 40% of the total expenses. In other words, the one or more weights in the transaction parameters may be viewed as assigned liability for each user. Each payment or expense incurred by a user in the event goes toward covering the assigned liability of that user. If a user incurs expenses exceeding his/her percentage of liability in the event, that user now has an asset in the event. As such, settlement of all transactions within an event may occur according to the defined transaction parameters of that event.

In obtaining the transaction parameters, in some examples, the users participating in each event may submit their expenses to the system (e.g., the TMS 150 in FIG. 1), and the system may receive expenses from each user who has paid some expenses for the event. For example, the system (e.g., the TMS 150 in FIG. 1) may receive information from a user interface of the electronic device associated with the user. For example, the user may use a mobile application on his/her mobile device to enter the amount of expenses which they spent for the party. Alternatively, and/or additionally, the process may receive an image of the user's receipt captured from the electronic device. In a non-limiting example, the user may use a build-in camera on his/her mobile device to capture the receipt and send the captured image to the system. Subsequent to receiving the captured image, the system (e.g., the TMS 150 in FIG. 1) or the mobile application engine 139 may perform an optical character recognition (OCR) over the captured image to convert the image to text, and extract the expense amount from the text to fill in the ETO. In some scenarios, the OCR may be performed by a cloud-based application to which the mobile device is communicatively coupled. Then the extracted data from the OCR process can be transmitted to the PTO which is then fed into the ETO. Alternatively and/or additionally, the system may be configured to detect a portion of the image that contains the expense amount. For example, the system (e.g., the TMS 150 in FIG. 1, or the mobile application engine 139) may detect a portion at the bottom of the image that contains a total amount paid, convert the detected portion to text, and extract the total amount from the converted text. The total amount from the converted text may be used to fill into the ETO.

In FIG. 2B, personal transaction unit (PTU) 210 may be configured to determine an accounting of total transactions for each of the users across the one or more events. In some examples, PTU 210 may include one or more sub-units, PTU(A), PTU(B), . . . PTU(N). Each sub-PTU may be coupled to one or more event transaction objects associated with a given user. For example, sub-unit PTU(A) may be coupled to one of more ETOs associated with user A. In the instant example, PTU(A) may be communicatively coupled to ETO1, ETO3, both of which involves user A. Similarly, PTU(B) may be communicatively coupled to ETO1, ETO2, ETO3, all of which involves user B. In some examples, user A has been part of event 1 and event 3, based on information in ETO1 and ETO3, the sub-unit PTU(A) may be configured to determine the accounting of total transactions associated with A across events 1 and 3. In other words, PTU(A) may incorporate the defined transaction parameters associated with ETO1 and ETO3.

In FIG. 2A, social transaction table 200 may include multiple rows (e.g., 202, 204, 206, 208) and multiple columns (e.g., 230, 240, 250, 260). Each row and each column may respectively represent a user. Each row may include one or more transaction cells that are associated with a first user represented by the row in which the transaction cell is located and a second user represented by the column in which the transaction cell is located. For example, transaction cell 242 is located in the first row 202 (representing user A) and the second column 240 (representing user B), thus is associated with user A and user B. In some examples, each transaction cell in the social transaction table 200 may include the event transaction objects that involve the users associated with that cell. For example, transaction cell 242 may include ETO1 and ETO3, where both ETO1 and ETO3 involve user A and user B. As such, transaction cell 242 includes all of the transaction relationships between user A and user B that occurred across various events.

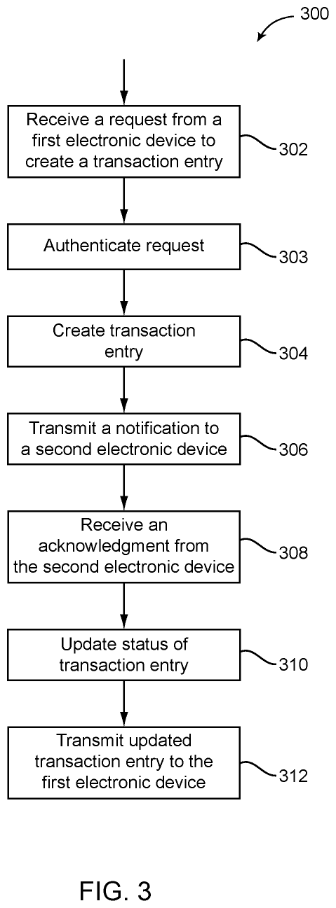

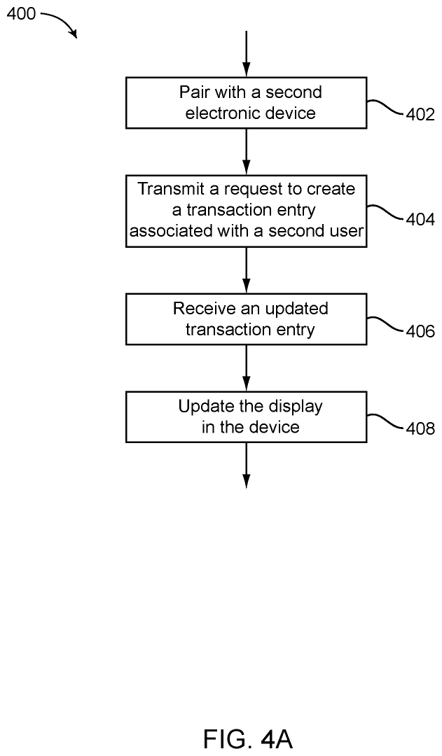

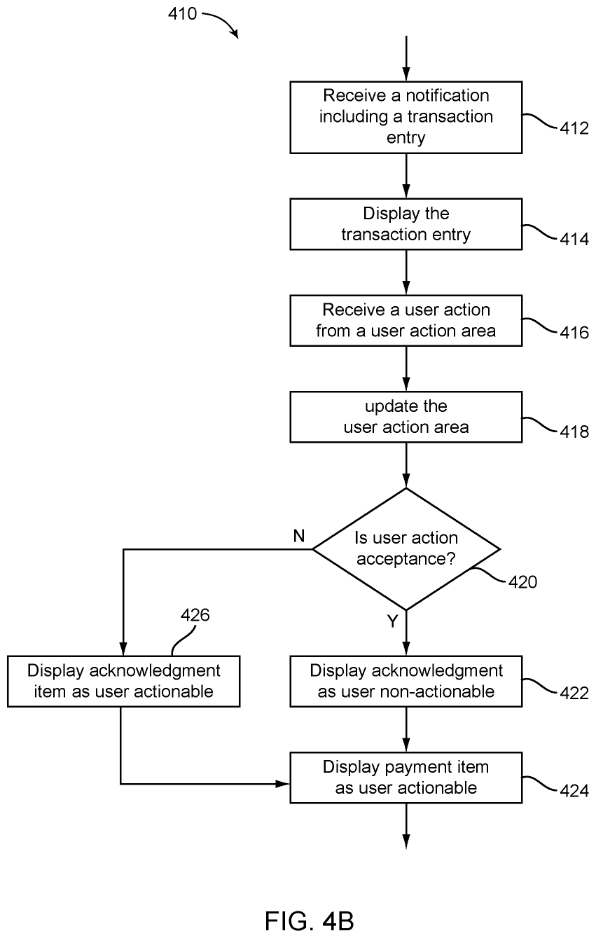

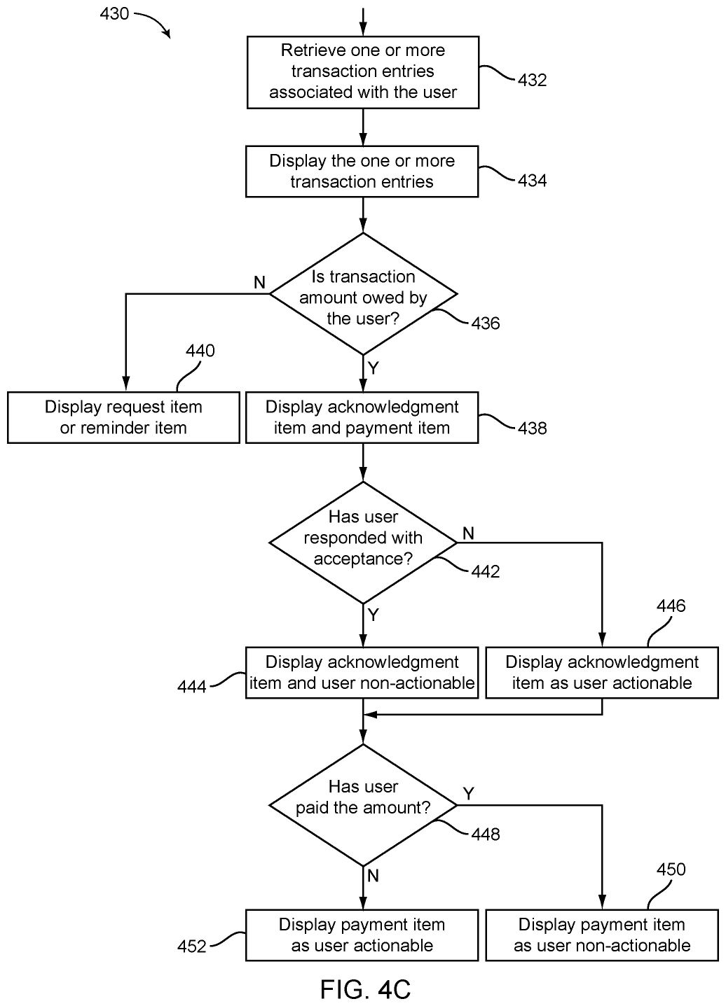

With further reference to FIG. 1, the data structures presented in social transaction table (200 in FIG. 2), personal transaction unit (210 in FIG. 2) and event transaction object (220 in FIG. 2) may facilitate improvement of computer technologies in determining liabilities between users. For example, mobile application engine 139 may be communicatively coupled to the at least one event transaction object 220 to create a communication portal between at least two users and with at least one event transaction object, where the defined transaction parameters in the event transaction object(s) are set responsive to a command from an electronic device associated with a user via the communication portal. The details of the solution are further explained in FIGS. 3-4.

FIG. 3 illustrates an example of a process for managing and sharing transaction information in accordance with some examples disclosed herein. In some examples, a process 300 may be implemented in a system, e.g., transaction management module (132 in FIG. 1), to manage and share transaction information among multiple electronic devices across multiple events, where each electronic device may be associated with a user, and each event may involve one or more users. In FIG. 3, process 300 may include receiving a request at 302, via a communication link (e.g., 120 in FIG. 1), where the request is sent from a first electronic device associated with a first user to create a transaction entry associated with a second user. The second user may be associated with a second electronic device. For example, the first and second electronic device may be any of the electronic devices on the communication network 105, such as 102(1) and 102(2). Each of the first and second electronic devices, e.g., 102(1) and 102(2) may be respectively associated with the first user and the second user. Each of the first user and the second user may be registered with a database (e.g., 140 in FIG. 1).

In response to receiving the request from the first electronic device, process 300 may create the transaction entry in the database at 304, wherein the transaction entry is associated with the first user and the second user. A transaction entry includes information about a single relationship between two users that may result from an event. In other words, a transaction entry may indicate what amount user A owes user B after both users have participated in an event. Multiple transaction entries may exist between same two users, each transaction entry being associated with a different event. For example, if user A and user B have multiple financial relationships that result from multiple occasions, then multiple transaction entries may exist. A transaction entry may include the name and date of the event, the identities of users involved in the event, and the transaction amount owed (from one user to the other).

The transaction entry may further include the status of the transaction entry. For example, user A may send a transaction entry to user B to request payment indicated in the transaction amount in the transaction entry. User B owes the transaction amount to user A, and user B may choose to pay that amount or not to pay that amount. In some examples, the status of transaction entry may include acceptance or denial of the transaction entry (e.g., whether or not user B acknowledges the transaction in the event), a request to adjust the transaction amount (e.g., user B asks for a waiver of the transaction amount or ask for a reduced amount in lieu of paying the full amount), and whether a payment of the transaction amount is pending or complete.

Additionally, process 300 may authenticate the request at 303. In some scenarios, the process may require that the first electronic device and the second electronic device have already been paired before creating the transaction entry. The pairing of the first and second electronic devices may indicate that user A and user B have already had some relationship and that the request from user A to create the transaction entry may be legitimate. Alternatively, and/or additionally, the first electronic device may be configured to pair with the second electronic device before sending the request to create the transaction entry.

Additionally, and/or alternatively, process 300 may authenticate the request by requiring the user sending the request to register within the transaction management system 150 (in FIG. 1). Process 300 may also authenticate the request by both the user sending the request and the user receiving the request to register with the transaction management system 150 (FIG. 1), in which case any of the user may be remotely located from another and not in physical contact. For example, each of the mobile devices (102 in FIG. 1) may respectively communicate and pair with the transaction management system 150.

In some examples, once the request is authenticated at 303, process 300 may create one or more transaction entries associated between user A and user B, where each transaction entry may be associated with a separate event. In creating the one or more transaction entries, process 300 may access the social transaction table (e.g., 134 in FIG. 1) and find an appropriate entry for the user who requested to create the transaction entry. For example, if user A may have requested to create a transaction entry associated with user B, then process 300 may access a valid cell in the row corresponding to user A (e.g., 202 in FIG. 2) that is associated with user B (e.g., cell 242) to retrieve all of the ETOs that are associated with one or more events. Process 300 may determine the number of events associated between user A and user B based on the number of retrieved ETOs from the relevant cell (e.g., 242 in FIG. 2), and create one or more transaction entries, each resulting from a single ETO. In the instant example, two ETOs: ETO1 and ETO3 are retrieved from cell 242, subsequently process 300 creates two transaction entries. In creating the first transaction entry, the process may extract information from the first ETO, e.g., ETO1, with respect to the relationship between user A and user B resulting from event 1.

In some examples, each of the ETOs may be configured to pre-determine a relationship between any two patrons in the event associated with that ETO via one or more transaction parameters. For example, in a party, user A purchased $50 of supplies that are used for the party, while other remaining four users paid nothing. If the cost of the party is to be equally divided among the patrons (e.g., each user has an equal weight), the ETO for the party may determine a relationship between user A and each of the other remaining four patrons, in which each of the remaining four patrons owes $10 to user A. In an example, the cost of the movie for two is $20, and user A and user B each have paid $10. If user A is assigned a weight of 30% and user B is assigned a weight of 70% in sharing the cost of a movie, then user B still owes $4 to user A. This participant-to-participant relationship information may be pre-determined by each ETO after the associated event is over and all of the participants have submitted all of the expenses which they have paid.

With further reference to FIG. 3, process 300 may transmit a notification to a second electronic device at 306 via the communication network, where the second electronic device is associated with the second registered user. In some examples, the notification may include one or more transaction entries that are associated between user A and user B. Each of the transaction entries may be created based on a respective event. For example, the first electronic device associated with user A may send two transaction entries to the second electronic device associated with user B, where the first transaction entry includes a transaction amount of $4 that user B owes to user A from a movie on February 5, and the second transaction entry includes a transaction amount of $11 that user B owes to user A from a lunch on March 15.

In some examples, process 300 may receive an acknowledgment from the second electronic device at 308, where the second electronic device is associated with user B and the acknowledgement is in response to the notification to user B. The acknowledgement may include user B's response to each of the transaction entries transmitted from the first electronic device to the second electronic device, where the response indicates whether user B has accepted or denied the transaction amount in each transaction entry, whether user B has requested to waive the transaction amount or has paid whole or a portion of the transaction amount. Upon receiving the acknowledgement from the second electronic device, process 300 may update the status of each of the one or more transaction entries based on the acknowledgment at 310. In some examples, process 300 may transmit the one or more updated transaction entries to the first electronic device at 312. In receiving the updated transaction entries, the first electronic device may display the information from the updated transaction entries to the first user, which is further described with reference to FIG. 4.

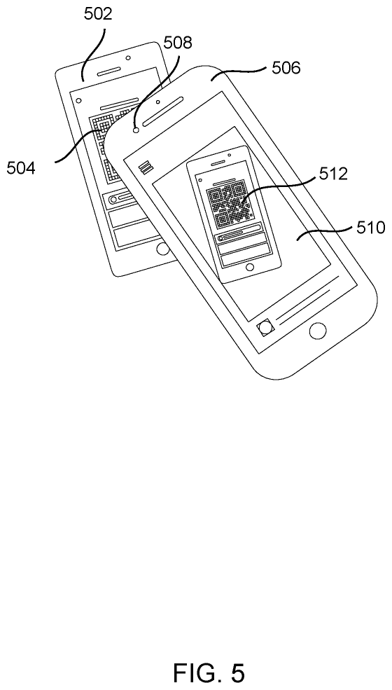

FIGS. 4A-4C illustrate examples of a process that may be implemented in an electronic device in accordance with some examples disclosed herein. In some examples, a process 400 may be implemented in an electronic device, such as 102 in FIG. 1. In FIG. 4A, process 400, which may be implemented in a first electronic device, may include pairing with a second electronic device at 402. For example, in FIG. 5, a first mobile phone 502 may be associated with user A, and a second mobile phone 506 may be associated with user B. When user A and user B meet at a movie theater, user A and user B pair their phones together, which allows the system (e.g., the TMS 150 in FIG. 1) to later authenticate any user device (e.g., 303 in FIG. 3). In the instant example, in pairing with another device, the first mobile phone 502 may display a barcode unique to the user associated with that mobile phone (e.g., user A) on a display 504 of the first mobile phone. The second mobile phone 506 may use a built-in camera 508 that is configured to capture the barcode on display 504 of first mobile phone 502. The second mobile phone 506 may perform image analysis on the captured image 510, identify the location of the barcode (e.g., 512) in the captured image, and decode the located barcode. In some examples, the barcode 512 may include the user ID for user A, the registration number of user A in the distributed communication system 100, user A's email address, or any information that may uniquely identify the user associated with the mobile device. Once user A and user B are paired, both users may be registered with the distributed communication system 100. Alternatively, and/or additionally, each user may respectively register with the system 100. In some examples, in an event involving multiple parties, each user's electronic device may pair with the electronic device of each other user participating in the event or the electronic device of the administrator of the event.

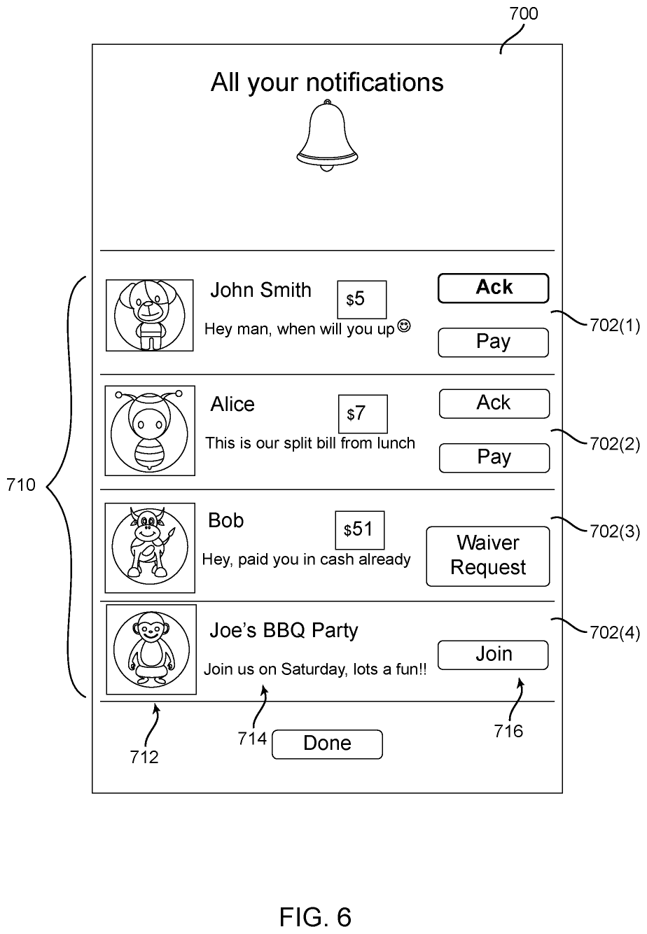

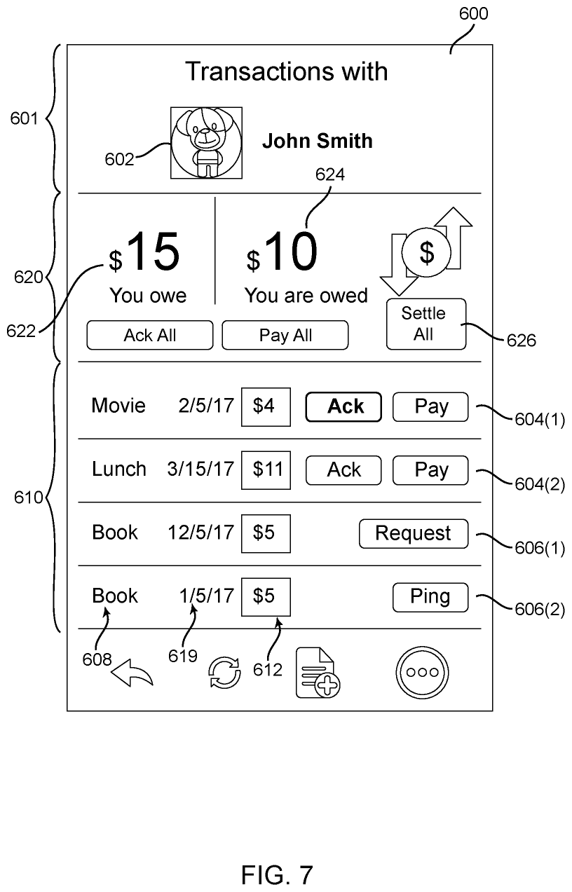

Returning to FIG. 4B, process 400 may transmit a request to create a transaction entry associated with a second user at 404. In some scenarios, the process 400 may transmit the request to the transaction management module (e.g., 132 in FIG. 1) on the distributed communication network 105 and create one or more transaction entries associated between multiple users. Process 400 may further include receiving one or more updated transaction entries from the communication network at 406 and updating the display in the device at 408. Various processes are described in detail in FIGS. 4B and 4C, with examples in FIGS. 6-7.

With reference to FIG. 4B and FIG. 6, on a receiving user's electronic device, a process 410 may include receiving a notification including a transaction entry at 412, and displaying the received transaction entry at 414. For example, FIG. 6 illustrates multiple notifications that a user's electronic device receives from multiple users. Each of received transaction entries may represent a relationship between the current user and each of the multiple sending users. The user device may include a user interface 700, which includes one or more regions. For example, the user interface 700 may include a transaction notification region 710 to display one or more transaction entries, such as 702(1), 702(2), 702(3) and 702(4). In the transaction notification region 710, the user interface may further include multiple sub-regions for each transaction entry. For example, for each transaction entry, the user interface may include an identity area 712 to include the identity of the user who requested the transaction entry to be created, a description area 714 to include the context of the event and transaction, and a user action area 716. The user action area 716 may further include one or more user-actionable items that allow user to interact with each transaction entry.

With further reference to FIG. 4B and FIG. 6, process 410 may operate to actuate settlement of liabilities incurred by a first user toward a second user across one or more events. The settlement may include the first user communicating an offer to provide a good or service and receiving an acknowledgment of the provided good or service to cure liability incurred by the first user toward the second user. For example, process 410 may include receiving a user action from a user action region at 416 and updating the user action region at 418. For example, in transaction entry 702(1), the user action region may include a user actionable button “Ack.” The process 410 may determine whether the user action is an “acceptance” (to a transaction entry sent by another user) at 420. If the user action is not an “acceptance,” the process may continue displaying “Ack” item as user actionable at 426. If the user action is “acceptance,” the process may disable an action to “acceptance” and display “Pay” button as user-actionable at 424, to facilitate user with payment instrument (e.g., payment instrument 130 in FIG. 1). In the example in transaction entry 702(1), the “Ack” and “Pay” buttons may be displayed simultaneously, and once user clicks on “Ack,” the process will gray out the “Ack” button and cause the “Pay” button to become user-actionable.

With further reference to FIG. 6, the user interface 700 may include a user-actionable button “Waiver” that allows the user to waive a specific transaction entry. For example, in transaction entry 702(3), the status of the transaction entry may include a “denial” which indicates that the user who owes the transaction amount have disputed the transaction entry. In the instant example, user Bob disputed with a comment that the transaction amount was already paid in cash. In response to determining that the status of the transaction amount is a “denial,” the process may display a user-actionable button, such as “Waiver” to allow user to waive off the payment and update the transaction entry status as “paid.” In response to the update of the status, the user interface 700 may update the user actionable area for transaction entry 702(3) to gray out the “Waiver” button or cause the button to display “paid.” In some examples, when a user selects to waive an owed amount from another user, the system (e.g., the TMS 150 in FIG. 1), the personal transaction unit may reduce the liability incurred by the user who requests the waiver proportionate to an apportionment value in the associated transaction entry.

FIG. 4C illustrates an example of a process for displaying detailed transactions associated with a given user. In some examples, a process 430, which may be implemented on a user's electronic device (e.g., any of the electronic devices 102 in FIG. 1), may include retrieving one or more transaction entries associated with a particular user at 432 and displaying the retrieved transaction entries on the display at 434. For example, FIG. 7 illustrates all of the transactions, in which the current user is associated with user John Smith. In some scenarios, in FIG. 7, in displaying the one or more transaction entries at 434 (FIG. 4C), process 430 may cause the mobile device to display a user interface 600, which may include various regions. For example, user interface 600 may include a region at 601 to show the identity of the second user, e.g., John Smith at 602. User interface 600 may also include a transaction region at 610, which displays the multiple transactions, such as 604(1), 604(2), 606(1), and 606(2). For each of the transaction entries, the user interface may display one or more attributes. For example, the user interface 600 may include the name of the event or context in which the transaction has occurred at 608, such as movie, lunch, book, party etc. The user interface may also display the date when the event occurred at 619 and the transaction amount at 612. In some scenarios, the transaction amount may be displayed in different colors, shading, fonts or any visual or audio attribute that may distinguish between an “owing” and “owed” amount. For example, the transaction entries 604(1), 604(2) show the owing amount that the user associated with the mobile device owes to John Smith displayed at 602. The transaction entries 606(1) and 606(2) show the owed amount that John Smith owes to the user of the mobile device.

In some examples, the user interface 600 may also include a summary region 620, which displays aggregated transaction amount that the current user associated with the electronic device, e.g., user A, owes to the other, e.g., user B, or the amount that user A is owed by user B. Each of the owing or owed amount is accumulated from the transaction amount of each of the transaction entries. In the instant example, based on the transaction entries displayed at 610, the total amount that the user of the mobile device owes to user B is $15, and the total amount that user B owes to user A is $10. The aggregated transaction amount may, for example, account for the weight associated with each of the users A and B for respective ones of the events, as well as any expenses incurred in each event.

In some examples, the user interface 600 may include one or more user-actionable items for each transaction entry depending on whether the transaction amount of the transaction entry is an owing amount (i.e., liability) or an owed amount (i.e., asset). With further reference to FIG. 4C, process 430 may further include determining whether the transaction amount for each transaction entry is an owing amount that is owed by the current user or an owed amount to the current user at 436. If the transaction amount is not an owning amount, process 430 may display a user-actionable “Request” item or “Ping” item. This is further explained with reference to the examples in FIG. 7. Transactions 606(1), 606(2) both show an owing amount that the current user owes to John Smith. The user interface 600 may include a “Request” button (e.g., in 606(1)), which is clickable by the user, and which, upon a user click, may cause the system (e.g., the TMS 150 in FIG. 1) to send a payment request (confirmation) to user B (e.g., John Smith) for user B to acknowledge. For example, the mobile application engine 139 communicatively coupled to the user devices 102 may be actuated responsive to the user click or swipe on the display. The mobile application engine 139 is configured to transmit SMS messages that include the payment request and the acknowledgement or confirmation from the recipient of the payment request.

As shown in FIG. 7, once a user activates the “Request” button, such as in transaction entry 606(1), the system (e.g., the TMS 150 in FIG. 1) may update the status of the transaction entry as “requested.” User B, who receives the request may respond by acceptance, which may cause the system to update the status of the transaction entry as “acceptance.” The user device may receive the updated transaction entry and update the display of the user device according to the updated transaction entry. For example, in FIG. 7, in the event that a payment request has been accepted by the receiving user, the user interface may display “Ping” instead of “Request” to indicate that the transaction entry is acknowledged by the receiving user but not paid yet. See transaction entry 606(2), for example. The “Ping” button may be clickable by the user, which, upon a user click, may cause the system to send a payment reminder to the receiving user.

Returning to FIG. 4C, if the transaction for a transaction entry is an owing amount that is owed by the current user, the process 430 may display user-actionable items such as “Ack” item (to accept transaction entry) and “Pay” item (to pay transaction entry), each of which may be user-actionable or non-user-actionable depending on the status of each transaction entry. For example, in FIG. 7, the transaction amount of transaction entries 604(1), 604(2) is an owed amount that the current user, e.g., user A owes to user B. In this case, in FIG. 7, the user interface 600 may display user-actionable items associated with the owing transaction entry, which has a transaction amount that the current user owes to user B. For example, the user interface may include an “Ack” button that is clickable by the user which, upon a user click, may send an acknowledgement to the other user associated with the current transaction entry.

Each of the transaction entries may be communicated on the communication network 105 between user electronic devices, and may be updated via user interactions, where the updated user interface may also include the change of user-actionable buttons that dynamically change with each transaction entry being updated. With reference to FIG. 4C, for example, process 430 may further determine whether the user receiving the “Ack” request, such as user B, has responded with acceptance at 442. If user B has accepted the transaction entry, the process 430 may display the “Ack” item as non-user-actionable at 444. If user B has not accepted the transaction entry, the process 430 may continue displaying the “Ack” button as user-actionable item at 446. In the example in FIG. 7, the “Ack” button for each transaction entry 604(1) and 604(2) may be user-actionable (e.g., in 604(2)) or non-user-actionable (e.g., in 604(1)).

Returning to FIG. 4C, process 430 may also change the display of “Pay” item depending on the status of the transaction entry. The process 430 may determine whether the current user has paid the transaction amount at 448. If it is determined that the transaction amount is paid, the process 430 may display the “Pay” item as non-user-actionable at 450. Otherwise, the process 430 may display the “Pay” item as user actionable, which allows the current user to select to pay.

In another example, as shown in FIG. 7, if a transaction amount is an owing amount, such as shown in transaction entry 604(1), upon the user acknowledging the transaction entry, the system (e.g., the TMS 150 in FIG. 1) may update the status of the transaction entry as acceptance. The user device, which acknowledges the transaction entry, may receive the updated transaction entry and update the display of the transaction entry. In the instant example, the “Ack” button may become non-user actionable, such as shown as grayed out.

Additionally, and/or alternatively, the user interface may also include a “Settle All” button 626 that may be user clickable, and when clicked by the user, may cause the system (e.g., the TMS 150 in FIG. 1) to consolidate all of the liabilities between two users and make a single payment. For example, clicking “Settle All” may cause the system to consolidate all of the transactions between the user and John Smith (displayed in the area 610), for which the user owes John $15 and John owes the user $10 (see the area 620)—the end result is that the user owes John $5. In this case, clicking “Settle All” will result in the user paying $5 to John (e.g., via the payment instrument 130 in FIG. 1). Subsequently, the status of all of the transactions will be updated to reflect “paid,” while will be described in detail.

Additionally, and/or alternatively, the user interface may also include a “Pay” button that may be user clickable, and when clicked by the user, may cause the system to communicate with the payment instrument (e.g., 130 in FIG. 1) to facilitate payment to the other user. In facilitating the payment, the payment instrument may transmit currency from the first user who owes to the second user who is owed, to cure the liabilities incurred by the first user toward the second user. For example, clicking the “Pay” button in transaction entry 604(1) may trigger the payment instrument (130 in FIG. 1) to make the payment of $4 to the other user. In some examples, the payment process may be made automatically. In some other examples, the payment process may be interactive, which allows user to navigate the payment process. Examples of payment instrument may include an automatic or interactive process, such as using PayPal's payment windows, using a credit card company's portal, using a point of sales (POS) terminal, using Apple Pay, or any other suitable payment methods. Once the payment is made, the system may update status of the transaction entry as paid. In response, the user device receives the updated transaction entry and subsequently updates the display of the transaction entry. In this case, the “pay” button may become non-user actionable, e.g., grayed out. In some or other scenarios, the system (e.g., TMS 150 in FIG. 1) may operate to allow for each of the user's to separately transmit payment to the other via a financial instrument without having to rely on the system for implementing the financial transaction with other user devices. In other words, instead of invoking the payment instrument (e.g., 130 in FIG. 1), a user may invoke a financial transaction with another user (e.g., Paypal or bank transfer) independent of the system, e.g., 100 or TMS 150 in FIG. 1.

In some examples, if a user invokes a financial transaction and has paid independently, the system may allow the user to manually update the entry as “Paid.” For example, the “Pay” button in the user interface (e.g., 702(1), 702(2) in FIG. 6) may allow a user to manually enter a payment amount made by the user, and update the entry corresponding to the transaction. In some examples, the system (e.g., 100 in FIG. 1) may also include a dual-confirmation/handshake protocol to determine that a payment has been made and the payee has also received the payment. In a non-limiting example, supposing that user X initiates a transaction entry, whereas user Y owes user X a transaction amount. The dual-confirmation/handshake protocol may include: user Y updates the status of a transaction entry; the system sends a notification to user X to confirm receipt of the payment from user Y; and user X responds with “yes” or “no.” Upon user X confirming with “yes,” the system may update the status of the transaction entry as “paid”; otherwise, the status of the transaction entry remains “acknowledged.” Additionally, if the user X responds with “no,” the system may also send a notification to user Y to indicate that user X has not received the payment. User Y may further check with the financial institution to confirm the payment. The system may receive a confirmation from user Y to indicate that the transaction amount has been indeed paid, and subsequently sends a notification to user X to confirm receipt of payment. This messaging may continue until payment is paid and confirmed by user X.

Additionally, and/or alternatively, the owing user may respond to a transaction entry by not paying or paying a partial amount, in which case, the system (e.g., 100 in FIG. 1) may also facilitate a user interface to receive an explanation from the owing user. For example, the user interface (e.g., 700 in FIG. 6) may provide a drop-down menu for the owing user to select, where the drop-down menu includes a list of possible explanations. Examples of the explanations may include “incorrect amount,” “waiving whole amount,” “waiving partial amount,” etc. In a non-limiting example, the user interface may also provide a text box for the owing user to enter the reason as to why the transaction amount is not being paid. The system may subsequently transmit a notification to the owed user, where the notification includes the text of explanations provided by the owing user.

Once the notification is received by the owed user, the system may allow the user to take actions. For example, the user interface (e.g., 700 in FIG. 6) may allow the user to remove the transaction entry, thus to forgive the transaction amount owed by the owing user. In another example, the user interface may allow the owed user to enter a new transaction amount and update the transaction amount of the transaction entry with the new amount. Consequently, the system may resend a notification to the owing user.

In some examples, the system (e.g., 100 in FIG. 1) may allow either an owed user or an owing user to request a transaction entry to be created. For example, an owing user may send a request to the system to create a transaction entry with a current transaction amount. While the transaction amount of the transaction entry is not paid, the status of the transaction entry is “to be paid.” The system may subsequently send a notification to the owed party associated with the transaction entry. Once the notification is received by the owed party, there is no action required of that party. In some examples, the user interface (e.g., 700 in FIG. 6) may activate a “ping” button to allow the user to ping the owing party about the payment. In some examples, the user interface may also activate a “waive off payment” button to allow the user to waive the transaction amount.

In some examples, when a transaction entry is requested by the owed party, the user interface (e.g., 700 in FIG. 1) on the owing party may include an actionable button, “pay,” which, when clicked by the user, may invoke a payment instrument (e.g., 130 in FIG. 1), such as using third-party payment methods, e.g., PayPal. Alternatively, the owing party may independently make a payment, in which case, the system may allow the user sending the request to also enter the current transaction amount to indicate that the current transaction amount has been paid. In this case, the system may set the status of the transaction entry as “paid-unconfirmed.” Subsequently, the system may send a notification to the owed party for the owed party to confirm the transaction amount and receipt of payment. Once the notification is received by the owed party, the user interface on the display of the device associated with the owed party may display actionable buttons, such as “confirmed” or “dispute/not received.”

If the “confirmed” is clicked, the system may update the transaction entry with the status “paid” and consequently, the user interfaces of the devices associated with both owing and owed users may be updated to reflect the new status. If the “disputed” button is clicked, the system may allow the owed user to enter any text explaining the dispute, such as what the owed user feels is real amount or any other reason etc.

The system, e.g., 100 in FIG. 1 allows multiple electronic devices to communicate with each other, facilitating a user associated with each of the electronic devices to interact with each transaction entry, which is created either by that user or by another user associated with the transaction entry. In some scenarios, a user may have transactions with multiple users during a group event, in which case, the dual-confirmation/handshake protocol described herein may also be applicable. For example, the system may allow each owing user in an event to pay through the payment instrument (e.g., 130 in FIG. 1) or independent of the system.

In some examples, the system may use a public key infrastructure (PKI) to secure all transactions. For example, each of the transaction entry may be created with PKI, and each user device may need both a public key and a private key in order to display and update the transaction entry. The use of PKI makes all transactions non-repudiatable. The PKI is described in https://hub.packtpub.com/public-key-infrastructure-pki-and-other-concepts-cryptography-cissp-exam/, and various off-the-shelf PKI methods may be used.

In some examples, each user may have a key pair generated on the associated user device. The private key may, for example, be secured on the user device and remain with the device. The public key may be shared via the multiple user devices. In an example, the public key may be stored on a backend of the system, e.g., 100 in FIG. 1. In a non-limiting example, an example of a process for user to sign a transaction (e.g., “ask for money” or “confirm payment made” or “payment received”) may include: composing the transaction entry containing required details; adding a nonce (e.g., a current timestamp) to the transaction entry; computing a hash for the transaction entry including the nonce; signing the hash by encrypting it using the private key on the user device; and sending the transaction entry along with the nonce and the signature to a backend of the system (e.g., 100 in FIG. 1) for book-keeping purposes.

In some examples, an example of a process that may be implemented in the backend of the system (e.g., 100 in FIG. 1) may include: retrieving the public key of the user who has signed the transaction entry; decrypting the signature using the public key to obtain the hash; re-computing the hash for the transaction entry including the nonce; verifying that the hash and the recomputed hash are the same. If the hash and the recomputed hash are determined to be the same, then the backend of the system may determine that the user signed/authorized the transaction entry at a time given by the nonce. Otherwise, the system may determine that the transaction entry is not authorized.

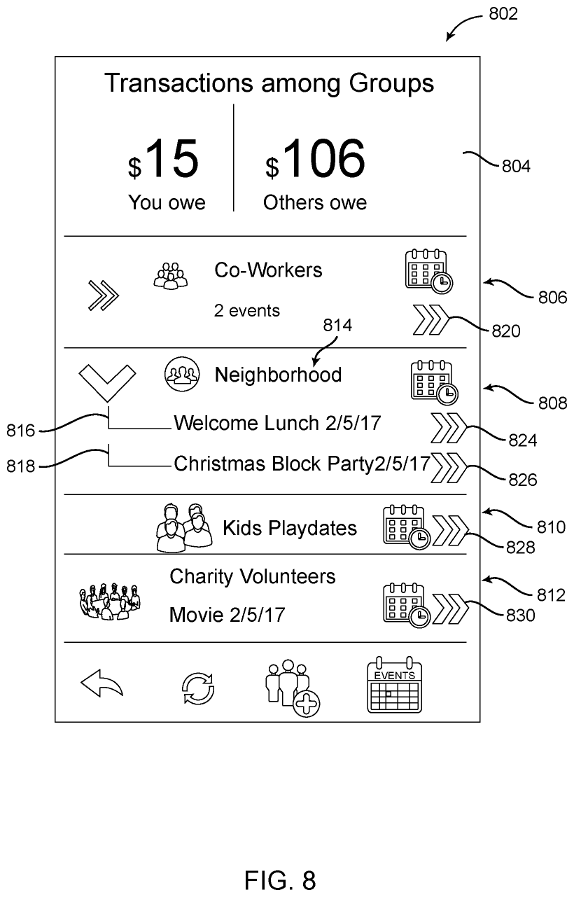

FIGS. 8-11 illustrates examples of transaction entries displayed on a user's electronic device. Each of the transaction entries may be associated with a group of users as opposed to an individual user. For example, FIG. 8 illustrates a group page in a user interface of an electronic device. The user interface may have a first area 804 configured to show the total amount that the user associated with the electronic device owes to others and the total amount that others owe to the user, as part of the group based transactions. These total amount is aggregated among all group based transactions across all events, and of all groups. In some examples, the user interface may include a second area that lists multiple group transaction entries, such as 806, 808, 810, and 812. Each group transaction entry may have three states: whether the user owes other users and have acknowledged same; whether the user owes others but have not acknowledged; or whether others owe to the user. For each group transaction entry, the user interface may display the names of events associated with each group. The user interface may also include a user-actionable button to allow a user to expand the events associated with the group. For example, for the neighborhood group at 808, the user interface displays the name of the group “Neighborhood” and also allows user to click on each entry to display the details of each entry. In the instant example, the group transaction entry is associated with two group events: “Welcome Lunch 2/5/17” at 816 and “Christmas Block Party 2/5/27” at 818. The user interface may also include a user-actionable item for each event, such as 820-830, which allows user to expand each event, which will cause the user interface to show event transactions.

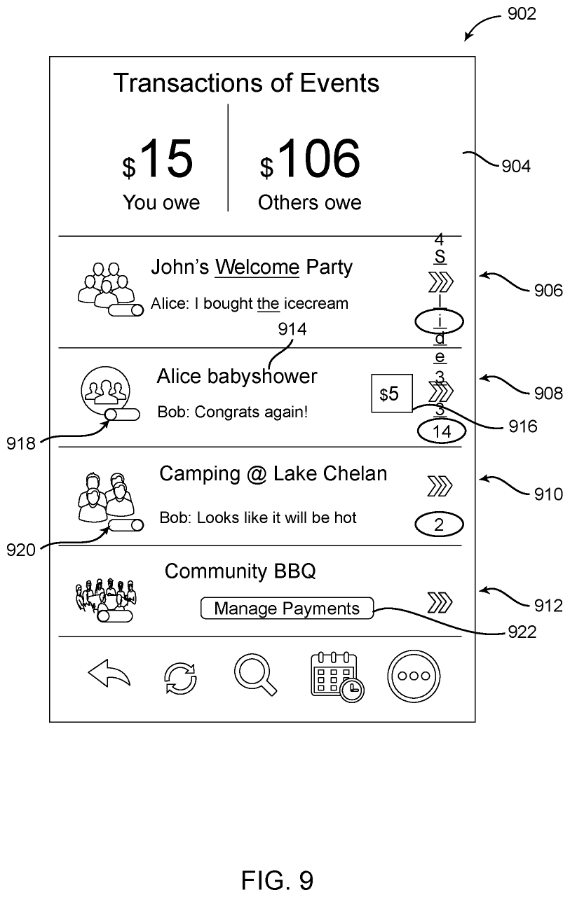

FIG. 9 illustrates an event transaction page in a user interface. In some examples, the user interface 902 may include a first area 904, which displays the total amount that the user owes to friends and the total amount that friends owe to the user, as part of taking part in events. The user interface may also include a second area that includes multiple event entries, such as 906, 908, 910 and 912. Each event entry may correspond to an event, and include information, such as the name of the event, whether the user acquired any liability (e.g., owes money) toward others by participating in the event. For example, in event entry 908, the user interface displays the name of the event “Alice babyshower” at 914 and the amount that the user owes at 916 from participating in the event.

In some examples, each event entry may also contain a flag to indicate whether the event has completed or whether the event is still ongoing. For example, the user interface shows a red bar at 918 to indicate that the event is over, whereas the user interface shows a green bar at 920 to indicate that the event is still ongoing. In some examples, on an event administrator's electronic device, a user interface may display a user actionable item, such as “Manage Payments” button at 922. The button 922 may be user actionable when the event is over. At that time, the user (e.g., the administrator of the event) may click the button to cause the system to rationalize all payments at the event. In the instance example, event 912 is a community BBQ, and upon the completion of the event, the administrator may click “Manage Payments” to cause the system to calculate the amount that each user owes or is owed. The transaction management system 150 updates the user interface displayed on each user's electronic device responsive to the TMS 150 calculating the liability or debt associated with each user. For example, after the Alice's baby shower at 908 is over, the user interface displays the total amount at 916, which indicates the amount that the user owes to the group by participating in the associated event.

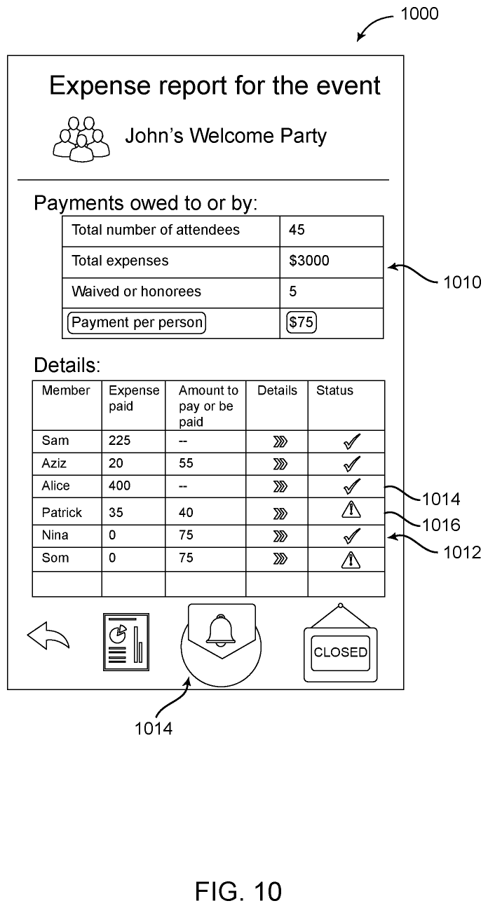

FIG. 10 further illustrates an example of a user interface that may be displayed on the display of an administrator's electronic device, to allow the user to rationalize the payment and send out payment notices to the event attendees. In some examples, the user interface 1000 may include a first area at 1010 to show a summary of the expenses and tally for a particular event. The user interface 1000 may also include a second area 1012 to show the details of per person payments. In some examples, the user interface 1000 may include a user-actionable item, such as a button 1014, which receives a user click to allow a user to send out notifications of payments to all attendees, with the details of each transaction. In sending the notifications of payment, the system may determine one or more transaction entries between each respective attendee and the administrator. For example, based on the payment per person (e.g., $75 in the instant example) and whether a particular user has already paid some expenses, the system may determine an amount that each user owes (to the event) or is owed (by other users). In some examples, the system may generate a new transaction entry (as described in this disclosure) that is associated with the user and the event (or the administrator). The TMS 150 (in FIG. 1) may also track the status of each transaction entry associated with each user. If the status of a transaction entry shows “paid,” the user interface 1000 may be updated to indicate current payment status for each user, such as showing a check mark at 1014. If the status of a transaction entry shows “unpaid,” the user interface 1000 may be updated to indicate the current the payment status, such as showing a red triangle 1016 to indicate that the user has not paid.

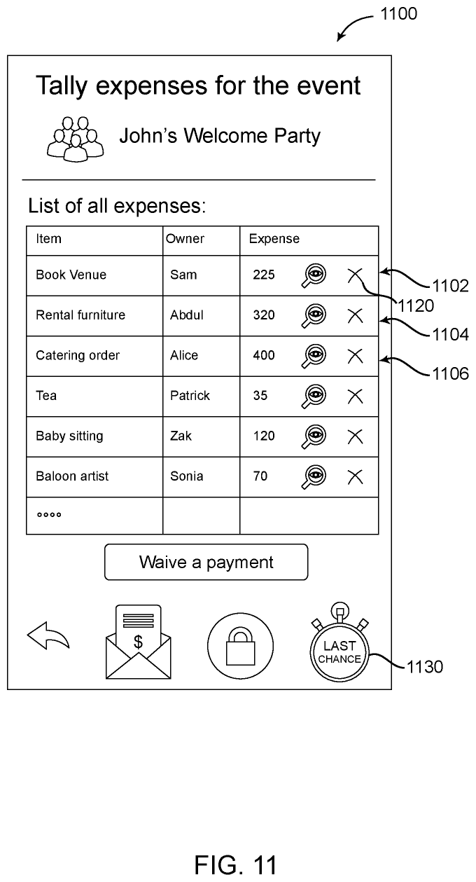

FIG. 11 further illustrates another example of a user interface that may be displayed on the display of an administrator's electronic device to allow the user to tally all the expenses for the event and calculate the payment owed to or by each user. In some examples, the use interface 1100 may include one or more expense entries, such as 1102, 1104 and 1106, to display a record for each expense associated with the event. As explained in this document, the system (e.g., the system 100 or the TMS 150 in FIG. 1) may allow each user to submit an expense. The user interface may include a user-actionable item for each expense entry to allow the administrator to verify an expense. For example, an “x” is displayed at 1120 for a corresponding entry that, upon a user click, will deny the expense submitted by the user.

In some examples, user interface 1100 may include an additional user-actionable item, such as a “last call” button at 1130, which, upon a user click, will cause the system to send a notification to all users as a last call for submitting the expenses.

Various methods may be implemented in sending notifications to the user. In some examples, the system (e.g., the system 100 in FIG. 1) may send a text message to a user's electronic device via SMS. Additionally, and/or alternatively, the system may send a HTTP packet to a user's electronic device. Upon receiving the HTTP packet, the receiving user's electronic device parses the HTTP header and payload, and extract the content of the message (e.g., a transaction entry, an event entry etc.) from the payload for displaying in the user interface.

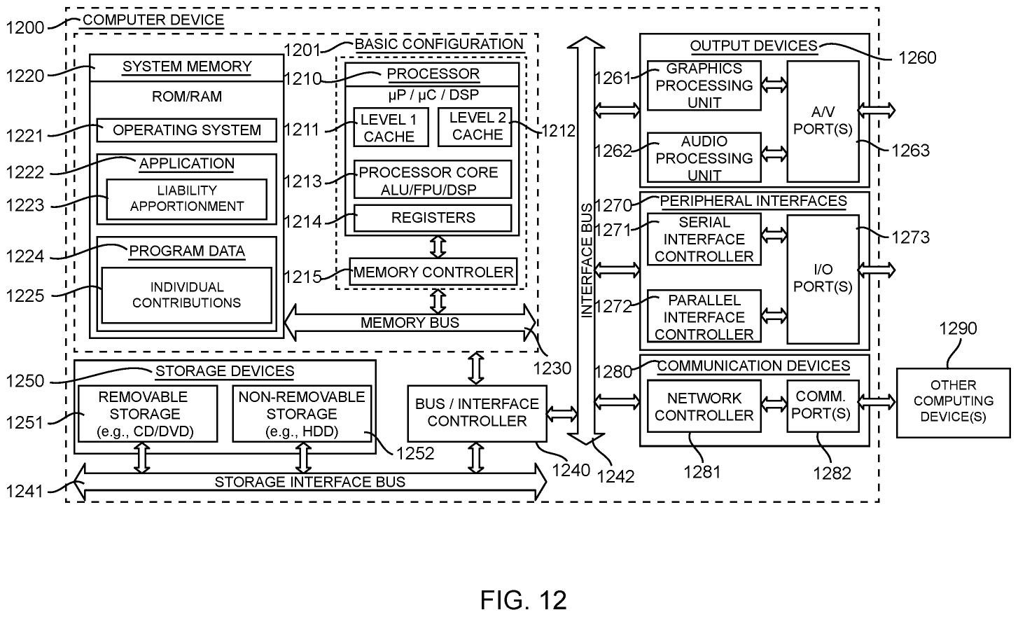

FIG. 12 is a block diagram illustrating an example transaction management system 150 (FIG. 1) in the form of a computer device 1200 arranged for tracking transactions between users in one or more events, automatically settling all incurred debts or liabilities between users, and real-time communication between users in accordance with the present disclosure. In a very basic configuration 1201, the computer device 1200 typically includes one or more processors 1210 and system memory 1220. A memory bus 1230 may be used for communicating between the processor 610 and the system memory 1220.

Depending on the desired configuration, processor 1210 may be of any type including but not limited to a microprocessor (μP), a microcontroller (μC), a digital signal processor (DSP), or any combination thereof. Processor 1210 may include one more levels of caching, such as a level one cache 1211 and a level two cache 1212, a processor core 1213, and registers 1214. An example processor core 1213 may include an arithmetic logic unit (ALU), a floating point unit (FPU), a digital signal processing core (DSP Core), or any combination thereof. An example memory controller 1215 may also be used with the processor 1210, or in some implementations the memory controller 1215 may be an internal part of the processor 1210.

Depending on the desired configuration, the system memory 1220 may be of any type including but not limited to volatile memory (such as RAM), non-volatile memory (such as ROM, flash memory, etc.) or any combination thereof. System memory 1220 may include an operating system 1221, one or more applications 1222, and program data 1224. Application 1222 may include liability apportionment 1223 to each user per respective ones of the events based on the one or more transaction parameters. Program Data 1224 includes the particular individual contributions 1225 of users toward respective events, where the contributions may be at least one of monetary, goods, or services, as described above. In some embodiments, application 1222 may be arranged to operate with program data 1224 on an operating system 1221 such that the users within a respective event are all individually notified of the amount of individual contributions outstanding or owed to the respective individual users. Additionally, the operating system 1221 aggregates amounts of outstanding contribution balances owed by other users in the respective event and facilitates actuation of the mobile application engine 139 to transmit communication between users and between respective users and the TMS 150, as described above. This described basic configuration is illustrated in FIG. 12 by those components within dashed line 1201.

The computer device 1200 may have additional features or functionality, and additional interfaces to facilitate communications between the basic configuration 1201 and any required devices and interfaces. For example, a bus/interface controller 1240 may be used to facilitate communications between the basic configuration 1201 and one or more data storage devices 1250 via a storage interface bus 1241. The data storage devices 1250 may be removable storage devices 1251, non-removable storage devices 1252, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1220, removable storage 1251 and non-removable storage 1252 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computer device 1200. Any such computer storage media may be part of device 1200.

Computer device 1200 may also include an interface bus 1242 for facilitating communication from various interface devices (e.g., output interfaces, peripheral interfaces, and communication interfaces) to the basic configuration 1201 via the bus/interface controller 1240. Example output devices 1260 include a graphics processing unit 1261 and an audio processing unit 1262, which may be configured to communicate to various external devices such as a display or speakers via one or more A/V ports 1263. Example peripheral interfaces 1270 include a serial interface controller 1271 or a parallel interface controller 1272, which may be configured to communicate with external devices such as input devices (e.g., keyboard, mouse, pen, voice input device, touch input device, etc.) or other peripheral devices (e.g., printer, scanner, etc.) via one or more I/O ports 1273. An example communication device 1280 includes a network controller 1281, which may be arranged to facilitate communications with one or more other computing devices 1290 (e.g., devices 102) over a network communication link via one or more communication ports 1282.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computer device 1200 may be implemented as a portion of a small-form factor portable (or mobile) electronic device such as a cell phone, a personal media player device, a wireless web-watch device, a personal headset device, an application specific device, or a hybrid device that includes any of the above functions. Computer device 1200 may also be implemented as a personal computer including both laptop computer and non-laptop computer configurations. In another example, the computer device 1200 may be a cloud-based server system communicative coupled to the control device 110 and the beacons 115 via the network 125.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the above descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

What is claimed is:

1. A social transaction management system, the system comprising:
at least one event transaction object configured to track transactions of at least one of first and second users for respective one or more events, wherein the tracked transactions have defined transaction parameters associated with respective ones of the one or more events; and
at least one personal transaction unit communicatively coupled to the at least one event transaction object and configured to determine an accounting of total transactions for each of the first and second users across the one or more events, the accounting of total transactions incorporates the defined transaction parameters associated with the respective one or more events; and
a mobile application engine communicatively coupled to the at least one event transaction object to create a communication portal between the at least one of the first and second users and with the at least one event transaction object, wherein the defined transaction parameters are set responsive to a command from at least one of the first and second users via the communication portal.

2. The system of claim 1, wherein the transactions comprise an exchange of at least one of a currency, a good, or a service between the first and second users.

3. The system of claim 1, wherein the mobile application engine is operable to actuate settlement of liabilities incurred by the first user toward the second user across the one or more events.

4. The system of claim 3, wherein the settlement comprises accessing a payment instrument associated with the first user and transmit currency to the second user to cure the liabilities incurred by the first user toward the second user.

5. The system of claim 3, wherein the settlement comprises the first user communicating an offer to provide a good or service and receiving an acknowledgment of the provided good or service to cure liability incurred by the first user toward the second user.

6. The system of claim 3, wherein the defined transaction parameters comprise an expense accumulated by one of the first and second users for a respective one of the one or more events.

7. The system of claim 6, wherein the personal transaction unit reduces an amount owed by the first user to the second user in a first one of the one or more events based on the expense.

8. The system of claim 3, wherein the defined transaction parameters comprise an apportionment value assigned to the first or second users in a first one of the one or more events.

9. The system of claim 8, wherein the personal transaction unit reduces a liability incurred by the first or second user in a first one of the one or more events proportionate to the apportionment value.

10. The system of claim 3, wherein the defined transaction parameter comprises an associated monetary value for a service offered by a first user to a second user to reduce a liability incurred by the first user to the second user in a first one of the one or more events.

11. The system of claim 3, wherein the mobile application engine is configured to transmit a liability notification to the first user responsive to an outstanding liability of the first user toward the second user in one of the one or more events.

12. The system of claim 11, wherein the mobile application engine is configured to transmit an acknowledgement notification from the first user to the second user responsive to the liability notification.

13. A system comprising:
a processor;
a communication peripheral configured to communicate with a plurality of electronic devices, each electronic device is associated with a user;
a database of registered users communicatively coupled to the processor, the database containing one or more transaction entries, each transaction entry including a transaction value and status; and
a non-transitory computer medium containing programming instructions that, when executed, will cause the processor to:
receive a request, via the communication peripheral, sent from a first electronic device associated with a first registered user to create a transaction entry associated with a second registered user;
in response to receiving the request, create the transaction entry in the database, wherein the transaction entry is associated with the first registered user and the second registered user;
transmit a notification via the communication peripheral to a second electronic device associated with the second registered user, wherein the notification includes the transaction value and the status of the transaction entry;
receive an acknowledgment responsive to the notification from the second electronic device; and
update the status of the transaction entry based on the acknowledgment.

14. The system of claim 13, the programming instructions contain additional programming instructions configured to cause the processor to transmit the updated status of the transaction entry to the first electronic device.

15. The system of claim 13, wherein the acknowledgment includes information indicative of acceptance of the transaction entry, a denial of the transaction entry, a request to adjust the transaction value in the transaction entry, or a payment of the transaction value in the transaction entry.

16. The system of claim 13, wherein the transaction value is an owed amount from the second user to the first user or an owed amount from the first user to the second user.

17. The system of claim 13, wherein the programming instructions contain additional programming instructions configured to cause the processor to authenticate the request to create the transaction entry by checking whether the first electronic device has paired with the second electronic device.

18. The system of claim 13, wherein at least one of the one or more transaction entries in the database includes an event field indicating an event at which the transaction value in that at least one transaction entry has occurred.

19. A method comprising:
pairing, by a processor of a first electronic device in a distributed system, with a second electronic device in the distributed system, wherein the first electronic device is associated with a first user and the second electronic device is associated with a second user;
transmitting, by the processor, a request to the distributed system to create a first transaction entry in a database of the distributed system, wherein the first transaction entry is associated with the second electronic device and includes a transaction value;
in response to the second electronic device receiving the first transaction entry, receiving, by the processor, a first updated transaction entry, wherein the first updated transaction includes transaction status of the first transaction entry based on a first acknowledgment from the second electronic device.

20. The method of claim 19 further comprising:
receiving a notification, via a communication peripheral of the first electronic device, from a third electronic device associated with a third registered user, wherein the notification includes a second transaction entry comprising a transaction value;
displaying the second transaction entry in a display region of a display of the first electronic device, wherein the display region includes an identity of the third registered user, the transaction value of the second transaction entry, and a user action area, wherein the user action area is configured to receive a user action responding to the second transaction entry, wherein the user action includes one of:
an acceptance of the second transaction entry;
a denial of the second transaction entry;
a request to adjust the transaction value in the second transaction entry; or
payment of the transaction value in the second transaction entry;
updating the user action area by displaying an acknowledgement item and a payment item simultaneously in the display region, wherein:
when the user action is the acceptance of the second transaction entry, the acknowledgment item is user non-actionable and the payment item is user actionable.
